(19) United States
(12) Patent Application Publication
(10) Pub. No.: US 2008/0191853 A1
(43) Pub. Date: Aug. 14, 2008

(54) Pulse Generating Device, and Vehicle Display Apparatus Having the Device

(75) Inventors: Mitsunari Kojima, Tokyo (JP); Shinichi Kobayashi, Tokyo (JP); Hiroshi Hasegawa, Niigata (JP)

Correspondence Address: MCDERMOTT WILL & EMERY LLP, 600 13TH STREET, N.W., WASHINGTON, DC, 20005-3096, US

(73) Assignee: NIPPON SEIKI CO., LTD.

(21) Appl. No.: 10/586,662

(22) PCT Filed: Nov. 22, 2004
(86) PCT No.: PCT/JP2004/017333

§ 371 Date: Jul. 19, 2006

(30) Foreign Application Priority Data
Jan. 19, 2004 (JP) 2004-010004

(51) Int. Cl. B60Q 1/54; G01C 21/00

(52) U.S. Cl. 340/441; 701/200

(57) ABSTRACT

A vehicle display apparatus for displaying vehicle information has a pulse generating device. This pulse generating device includes at least: control means comprising a control part and an output part; and an output terminal (output means). The control part receives data of number of wheel rotations (wheel speed data) from an ABS unit mounted on the vehicle via a multiplex communication line, and generates, based on the received data of number of wheel rotations, a pulse signal that can be used for a retrofitted navigation unit (information display device) that is mounted on the vehicle later. The pulse signal generated by the control means is outputted from the output terminal through a wire member to the navigation unit.

### BACKGROUND OF THE INVENTION

1. Field of the Invention

The present invention relates to a pulse generating device for receiving vehicle speed information or wheel speed information from a control device mounted on a vehicle, thereby to generate a predetermined pulse signal that can be used for an information display device to be mounted on the vehicle, and to a vehicle display apparatus having that pulse generating device.

2. Background Art

The vehicle is managed by a control unit, which includes various computers mounted on the body side as it is systematized in recent years, such as the ABS (anti-lock/brake system) unit, the AT (automatic transmission) unit or the ECU (engine control unit). The main stream is being exemplified by the multiplex communications, in which data transfers are performed through multiplex communication lines (serial transfer passages) with various control devices such as an audio unit, an air conditioner unit (air-con unit) or a vehicle display apparatus. This vehicle display apparatus as the control device for the aforementioned multiplex communications can receive and display not only various pieces of information, e.g., not only the vehicle information such as the running speed, the engine speed and the fuel level but also alarm information (warning information) on the vehicle information or the direction indicating information associated with the direction indication unit. Here, this vehicle display apparatus is disclosed in Patent Document 1, Patent Document 2 and so on.

[Patent Document 1] JP-A-5-81589

[Patent Document 2] JP-A-11-201774

### SUMMARY OF THE INVENTION

In the recent years of multiplex communication techniques being advanced, data is transferred between the aforementioned individual control devices. In case, therefore, the user mounts a navigation unit (as will be called the “retrofitted navigation unit”) other than that of maker option, it is impossible to acquire such a precise pulse signal (speed pulses) dedicated to the vehicle kind as is indispensable for the retrofitted navigation unit. As a result, this retrofitted navigation unit cannot be mounted on the vehicle. To the contrary of the development of the vehicular systematization, therefore, there is left unsolved the problem that the degree of freedom for the vehicle customization cannot be enjoyed on the user side. Moreover, various pieces of vehicle information are inputted to the vehicle display apparatus as the aforementioned control device. Therefore, attentions have been growing higher and higher not only to the general using purpose to display the vehicle information but also to other functions as the control device.

The present invention has been conceived noting the problems thus far described, and contemplates to provide a pulse generating device of the type, in which a retrofitted control device needing a pulse signal can also be mounted on a vehicle of a multiplex communication processing and in which the vehicle customization can be improved on the user side, and a vehicle display apparatus having that device.

In order to solve the above-specified problems, according to a first aspect of the invention, there is provided a pulse generating device comprising: control means for receiving vehicle speed information or wheel speed information via a multiplex communication line from a control device mounted on a vehicle, and for generating, based on the vehicle speed information or the wheel speed information, a predetermined pulse signal that can be used for an information display device mounted on the vehicle; and output means for outputting the pulse signal generated by the control means, to the information display device.

In the pulse generating device according to a first aspect of the invention, according to a second aspect of the invention, the control means and the output means belong to a vehicle display apparatus for displaying the running information of the vehicle.

In the pulse generating device according to a first or second aspect of the invention, according to a third aspect of the invention, the control means outputs the pulse signal according to the running state of the vehicle.

In the pulse generating device according to a first aspect of the invention, according to a fourth aspect of the invention, the information display device is a navigation unit.

According to a fifth aspect of the invention, there is provided a vehicle display apparatus for displaying vehicle information, including a pulse generating device comprising: at least control means for receiving vehicle speed information or wheel speed information via a multiplex communication line from a control device mounted on a vehicle, and for generating, based on the vehicle speed information or the wheel speed information, a predetermined pulse signal that can be used for an information display device mounted on the vehicle; and output means for outputting the pulse signal generated by the control means, to the information display device.

In the vehicle display apparatus according to a fifth aspect of the invention, according to a sixth aspect of the invention, the control means outputs the pulse signal according to the running state of the vehicle.

In the vehicle display apparatus according to a fifth aspect of the invention, according to a seventh aspect of the invention, the information display device is a navigation unit.

According to the invention, it is possible to provide a pulse generating device of the type, in which a retrofitted control device needing a pulse signal according to the running state of a vehicle can also be mounted on a vehicle of a multiplex communication processing and in which the vehicle customization can be improved on the user side, and a vehicle display apparatus having that device.

### BRIEF DESCRIPTION OF THE DRAWINGS

FIG. 1 is a schematic view showing a vehicle display apparatus of a mode of embodiment of the invention;

FIG. 2 is a block diagram of the vehicle display apparatus of the same mode of embodiment;

FIG. 3 is a diagram showing a main processing program of the same mode of embodiment;

FIG. 4 is a diagram showing an interrupt processing program of the same mode of embodiment; and

FIG. 5 is a diagram showing the interrupt processing of the same mode of embodiment.

### DESCRIPTION OF THE PREFERRED EMBODIMENT

A mode of embodiment of the invention is described in the following with reference to the accompanying drawings.

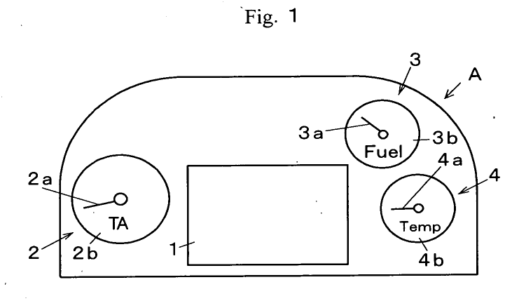

FIG. 1 is a schematic view showing a vehicle display apparatus of a mode of embodiment of the invention. The vehicle display apparatus A is composed of a liquid crystal display panel of a TFT or the like, or an organic EL panel or the like. Moreover, the vehicle display apparatus A is equipped with: a display part 1 for displaying various pieces of information, i.e., not only vehicle information such as a running speed, an engine speed or a fuel level but also alarm information (warning information) on the vehicle information or air-conditioning information from an air conditioner part; and indicators 2a, 3a and 4a mounted on a cross coil type body or a stepping motor type body. Still moreover, the vehicle display apparatus A includes a tachometer 2, a fuel gauge 3 and a thermometer 4 of analog meters for displaying the measured quantities when read at the ratios of the indicators 2a, 3a and 4a to number plates 2b, 3b and 4b arranged on the backs of the indicators 2a, 3a and 4a.

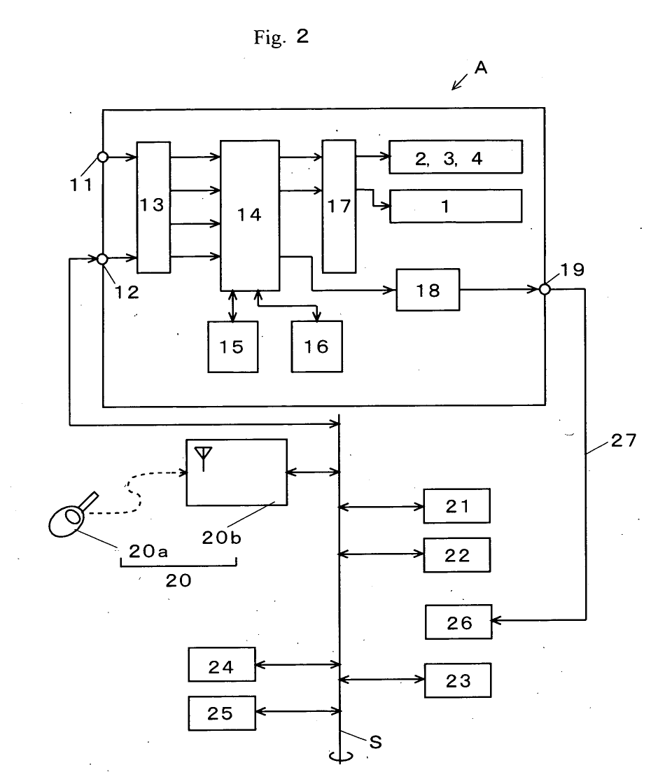

FIG. 2 is a block diagram showing the vehicle display apparatus A. This vehicle display apparatus A is configured to include a setting terminal 11 to be used for making various settings according to a vehicle kind, a multiplex communication input/output terminal 12 for inputting/outputting the vehicle information, vehicle interface (I/F) means 13 for receiving the vehicle information of multiplex communications, a control part 14 for controlling the vehicle display apparatus A, first storage means 15 made of a ROM or the like for storing a processing program, second storage means 16 made of an EEPROM, a flash memory or the like for registering the various settings, the display part 1 for displaying the various pieces of information, drive means 17 for controlling the display of the display part 1 and for driving the various analog meters 2, 3 and 4, transistors, current suppressing resistors and so on. On the other hand, the vehicle display apparatus A is equipped with an output part 18 adapted by the later-described processing operations to output a pulse signal according to the running state of the vehicle, and an output terminal (output means) 19 for outputting the pulse signal from the output part 18 to an external information display device or a later-described navigation unit. In this mode of embodiment of the invention, at least the control part 14 and the output part 18 constitute control means.

The control part 14 is made of a microcomputer having a CPU, a RAM and so on, and receives the various pieces of data such as the engine speed data, the fuel consumption data and the water temperature data from a later-described ECU via a multiplex communication line S. The control part 14 subjects the various data to a predetermined processing operation thereby to cause the display part 1, the tachometer 2, the fuel gauge 3 and the thermometer 4 to display the various pieces of vehicle information. Moreover, the control part 14 and the output part 18 generates a pulse signal in a processing flow, as will be detailed, and outputs the pulse signal through the output terminal 19 to the later-described navigation unit.

The multiplex communication line S is connected with the multiplex communication input terminal 12 of the vehicle display apparatus A. With the multiplex communication line S, there are connected: a keyless entry device (a transmitter 20a and a receiver 20b) 20 acting as user identifying means of the vehicle; an air conditioner 21 for managing the air condition of the vehicle; an audio system 22; an ECU 23; an ABS unit 24; an AT unit 25; and so on. A retrofitted navigation unit (navi unit) 26 is arranged in the vehicle, although not connected with the multiplex communication line S. The output terminal 19 of the vehicle display apparatus A and the navigation unit 26 are electrically connected via a wiring member 27 such as a hard wire, so that the pulse signal acquired by the vehicle display apparatus A (the control part 14) and according to the running state of the vehicle are precisely transmitted from the vehicle display apparatus A to the navigation unit 26.

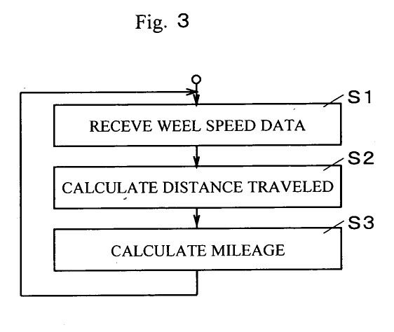

Next, one example of a method for generating the pulse signal in the control part 14 is described with reference to FIG. 2 to FIG. 5.

The control part 14 receives (at Step S1) the data of number of wheel rotations (as will be called the wheel speed data) of the wheels from the ABS unit 24 or a control device mounted on the vehicle via the multiplex communication line S, and determines (at Step S2) a traveled distance Lp by multiplying the data of number of wheel speed data and the tire circumference length of the vehicle, as preset and stored in the second storage means 16 through the setting terminal 11. Moreover, the control part 14 determines (at Step S3) the mileage XLp of the vehicle by adding the traveled distance Lp of this time to the traveled distance Lp calculated at the previous time, and displays the mileage XLp in the display part 1. Here, in the process of manufacturing the vehicle display apparatus A, data for the tire circumference length can be written in the second storage means 16 with a dedicated data writing device by connecting this data writing device with the setting terminal 11.

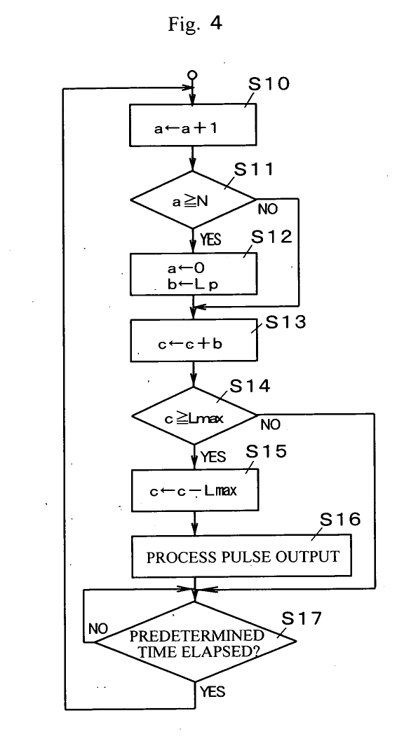

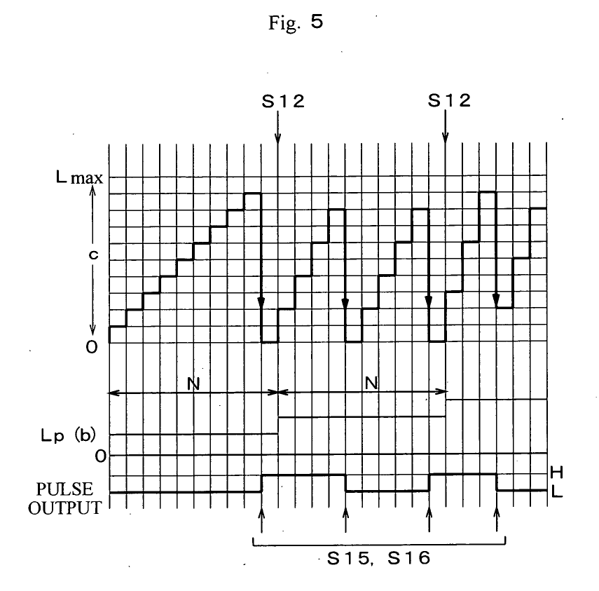

The processing flow of Step S1 to Step S3 thus far described is the main processing program for the control part 14 to determine the traveled distance. This main processing program has an execution cycle of 10 ms. Steps S10 to Step S17 in FIG. 4 and FIG. 5, as will be described in the following, indicate an interrupt processing program for the main processing program. This interrupt processing program has an execution cycle of 1 ms so that it is executed ten times, for example, for one execution of the main processing program.

For executing the interrupt processing program, the control part 14 executes (at Step S10) a counting operation of “a←a+1”, and compares (at Step S11) a counted value a and a predetermined number of times (N) (e.g., 10 in this case). If it is decided that the counted value a is not a number N or more, the routine advances to Step S13. At Step S13, the control part 14 executes “c←c+b (b=Lp)”, namely, the addition of a rewrite value b of the traveled distance Lp thereby to determine the added value (the added value of the traveled distance Lp) c. At a next Step (at Step S14), the added value c and a predetermined constant Lmax (as will be detailed) are compared (at Step S14). In case the added value c is smaller than the constant Lmax, the Steps S15 and S16 are passed not to execute the pulse signal generate processing that characterizes the present invention. It is, then, decided (at Step S17) whether or not the execution lapse time (1 ms) of the interrupt processing program is reached. If this reach is decided, the routine returns to Step S1. The operations thus far described are repeatedly executed so long as the pulse signal generate processing is not executed. On the other hand, the synchronize processing of the interrupt processing program and the main program is executed every time the counted value a becomes the predetermined number N (N=10).

Next, here will be described the case, in which the counted value a reaches the predetermined number N at Step S11 and in which the added value c becomes the constant Lmax or more (c≧Lmax). When the counted value a and the predetermined number N become equal, the control part 14 executes (at Step S12) not only the reset processing of the counted value a for “a←0” but also the data rewrite processing of “b←Lp”.

Next, the control part 14 determines (at Step S14) the added value c (c←c+b (b=Lp)), and decides at the next Step (at Step S14) whether or not the added value c is the constant Lmax or more. The constant Lmax is a reference constant that is determined by the input data, i.e., the traveled distance Lp, the traveled distance per unit time, and the output interval of the pulse signal, for generating the pulse signal.

The control part 14 sets, when it is decided that the added value c is the constant Lmax or more (c≧Lmax), the added value c to “c−Lmax” (“c←c−Lmax” at Step S15), and outputs (at Step S16) the pulse signal according to the running state of the vehicle, through the output part 18. Here, the control part 14 generates the formation timing (or the rise and fall of the pulse) of the pulse signal by turning ON/OFF the transistor owned by the output stage of the control part 14, so that the pulse signal according to the running state of the vehicle can be outputted by the voltage change of the output part 18.

Then, the control part 14 returns to Step S1 after it made decision on the execution lapse time of the interrupt processing program at Step S17. Therefore, the control part 14 generates at Step S16 the formation timing of the pulse signal according to the running state of the vehicle, and acquires the pulse signal by the output part 18 in response to that formation timing, so that it can transmit the pulse signal to the navigation unit 26 through the output terminal 19 and the wiring member 27.

The vehicle display apparatus A has the pulse generating device including: the control means having the control part 14 and the output part 18; and the output terminal 19. The control part 14 receives the wheel speed data from the ABS unit 24 or the control device mounted on the vehicle via the multiplex communication line S, and generates, based on the received wheel speed data, the pulse signal that can be used for the navigation unit 26 or the information display device that is mounted on the vehicle, that is, the pulse signal that is needed for the self position decide processing of the navigation unit 26. The pulse signal generated by the control means is outputted from the output terminal 19 via the wire member 27 to the navigation unit 26.

As a result, the retrofitted navigation unit 26 needing the pulse signal according to the running state of the vehicle can be mounted even on the vehicle that advances in the serial communication processing so that it cannot obtain the pulse signal according to its running state thereby to improve the customizability of the vehicle on the user side. Moreover, the vehicle display apparatus A is equipped with the pulse generating device so that it can play the role of not only the vehicle information display means only for collecting the vehicle information and displaying the various information but also the auxiliary control device for an information display device such as the navigation unit 26 mounted on the vehicle. Thus, it is possible to improve the additional value as the vehicle display apparatus A.

In the mode of embodiment of the invention, the configuration is made by equipping the vehicle display apparatus A with the pulse generating device. In the invention, the control part 14 of the vehicle display apparatus A is used as the control means. However, effects similar to those of the foregoing mode of embodiment can be obtained by preparing dedicated control means and by arranging such a pulse generating device in the vehicle as can acquire the pulse signal by that dedicated control means.

Moreover, the mode of embodiment of the invention uses the control part 14 for generating the pulse signal according to the vehicle running state on the basis of the vehicle wheel speed data. In the invention, however, the speed data according to the running state of the vehicle may also be inputted from the ECU unit 23 to the control means thereby to generate the pulse signal on the basis of that speed data.

Moreover, the mode of embodiment of the invention transmits the pulse signal generated by the control part 14, to the retrofitted navigation unit 26. In the invention, however, the pulse signal may also be fed to an information display device other than the navigation unit mounted on the vehicle.

The invention can be applied to the vehicle display apparatus having the pulse generating device for receiving the vehicle speed information or wheel speed information from the control device mounted on the vehicle, thereby to generate a predetermined pulse signal that can be applied to the information display device to be mounted on the vehicle.

What is claimed is:

1. A pulse generating device comprising: control means for receiving vehicle speed information or wheel speed information via a multiplex communication line from a control device mounted on a vehicle, and for generating, based on said vehicle speed information or said wheel speed information, a predetermined pulse signal that can be used for an information display device mounted on said vehicle; and output means for outputting said pulse signal generated by said control means, to said information display device.

2. A pulse generating device according to claim 1,
wherein said control means and said output means belong to a vehicle display apparatus for displaying the running information of said vehicle.

3. A pulse generating device according to claim 1 or 2,
wherein said control means outputs said pulse signal according to the running state of said vehicle.

4. A pulse generating device according to claim 1,
wherein said information display device is a navigation unit.

5. A vehicle display apparatus for displaying vehicle information, including a pulse generating device comprising:
at least control means for receiving vehicle speed information or wheel speed information via a multiplex communication line from a control device mounted on a vehicle, and for generating, based on said vehicle speed information or said wheel speed information, a predetermined pulse signal that can be used for an information display device mounted on said vehicle; and
output means for outputting said pulse signal generated by said control means, to said information display device.

6. A vehicle display apparatus according to claim 5,
wherein said control means outputs said pulse signal according to the running state of said vehicle.

7. A vehicle display apparatus according to claim 5,
wherein said information display device is a navigation unit.
